(19) United States
(12) Patent Application Publication
(10) Pub. No.: US 2010/0048266 A1
(43) Pub. Date: Feb. 25, 2010

(54) Antenna device

(75) Inventor: Akihiro Maruyama, Yokohama-shi (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/583,308

(22) Filed: Aug. 18, 2009

(30) Foreign Application Priority Data
Aug. 19, 2008 (JP) 210857/2008
Jul. 20, 2009 (KR) 10-2009-0066093

(51) Int. Cl. H04M 1/00; H01Q 1/38; H01Q 1/24; H04B 1/02; H04B 1/38

(52) U.S. Cl. 455/575.7; 343/700 MS; 343/702; 455/107

(57) ABSTRACT

Disclosed is a multi-band antenna device with a simplified design and fabrication method, which can be suitably mounted to a mobile phone, or the like. The disclosed antenna device includes a substrate, and an antenna element connected to a feed point of the substrate. The antenna element includes a right-left asymmetrical first antenna element, and a second antenna element mounted to the first antenna element, which are integrally formed, and is provided on the surface of a dielectric substance. The antenna device can be embedded in the terminal while obtaining a good VSWR value over a wide-band by the first antenna element. Also, in the antenna device, in a low frequency band which cannot be covered by the first antenna element, it is possible to obtain a good VSWR value by the second antenna element.

### CROSS-REFERENCE TO RELATED APPLICATION(S) AND CLAIM OF PRIORITY

The present application is related to and claims priority to application entitled “Antenna Device” filed with the Japanese Patent Office on Aug. 19, 2008 and assigned Serial No. 210857/2008, and Korean Intellectual Property Office on July 20, and assigned serial No. 10-2009-0066093, the contents of which are incorporated herein by reference.

### TECHNICAL FIELD OF THE INVENTION

The present invention relates to an antenna device, and more particularly, to a small-size multi-band antenna device built in a wireless terminal.

### BACKGROUND OF THE INVENTION

A built-in antenna for a mobile wireless device has been recently developed. Examples of such an antenna include a built-in antenna dedicated to a Ultra Wide Band (UWB) suitable for high-rate data communication, a cellular built-in antenna, or the like. When a terminal device is miniaturized, the antenna is also required to be miniaturized.

In a built-in antenna dedicated to a UWB, both the miniaturization and performance can be achieved compatibly by the shape design of an antenna element or a substrate. For example, Japanese Patent Laid-Open Publication No. 2007-235752 discloses a wide-band antenna element, which has a planar antenna formed of a metal or dielectric substrate, realizes a wide band through its shape design, and is fed by a coaxial cable. This may provide a miniaturized antenna satisfying a frequency band of more than 3 GHz.

Also, in a cellular built-in antenna, a multi-band is achieved by shaping an antenna element into an inverse-L or inverse-F shape, for example, antennas disclosed in Japanese Patent Laid-Open Publication Nos. 2007-123982, and 2005-150937.

In the multiband compatible antenna system disclosed in Japanese Patent Laid-Open Publication No. 2007-123982, the multi-band is achieved by using a primary resonance and secondary resonance through the combination of an inverse-F antenna with an inverse-L antenna. According to this technology, the multi-band in a frequency band in a range of 0.8˜2.2 GHz can be achieved. Also, in the antenna structure disclosed in Japanese Patent Laid-Open Publication No. 2005-150937, the multi-band is achieved by changing a resonant frequency characteristic of an antenna by a semiconductor device.

In general, when using any one of the above described technologies, the antenna shape can be more miniaturized by using a high dielectric-constant dielectric substance or a ceramic material as material for the antenna. Then, the volume of the fabricated antenna is mainly in the range of about 2˜5 cc.

As described above, in the miniaturization of an antenna for a portable wireless device, various researches have been conducted. When due to system multi-functionalization or international roaming, a portable terminal requires multiple wireless systems to be mounted therein; however, the above mentioned conventional antennas have following problems.

First, in order to deal with multiple wireless systems, multiple antennas are required. However, as described above, the minimization tendency and design constraints of a portable terminal device make it difficult to secure a space for carrying the multiple antennas.

Second, in the case of a technology of shaping an element into an inverse-L or inverse-F shape, the minimization of an antenna causes an increase in the quality factor (Q value) indicating resonance sharpness, and low emission efficiency and a narrow band of the antenna. Also, an error of a resonant frequency occurs and characteristic control is very difficult.

Third, when using a tunable circuit, a variable resonant frequency increases the difficulty in the design. Also, due to the requirement of devices, such as a switch or a variable capacitance diode, component unit cost or manufacture cost increases. Also, it is necessary to consider the possibility of the reduction or distortion of antenna emission efficiency, and the degradation of communication quality, which are caused by an adverse effect of a circuit.

### SUMMARY OF THE INVENTION

To address the above-discussed deficiencies of the prior art, it is a primary object to provide a built-in antenna for a terminal that can be easily miniaturized and can realize highly wide-band electrical characteristics without a semiconductor device, or the like.

In accordance with an aspect of the present invention, an antenna device is provided. The antenna device includes: a substrate including a feed point; a right-left asymmetrical first antenna element with a predetermined width; and a second antenna element mounted to the first antenna element, wherein the first antenna element has a taper-shape end portion contributing to a wide-band, and a round-shape or a taper-shape end portion precisely adjusting the amount of capacitance, and is fed by the connection of the round-shape or taper-shape end portion to the feed point, and the second antenna element is directly connected to the first antenna element at a position where the position does not contribute to the wide-band, and maintains resonance characteristics in a low frequency band where the resonance characteristics are not secured by the wide-band of the first antenna element.

Also, in the antenna device, the first antenna element is a wide-band monopole antenna with an electric field of quarter wavelength, the second antenna element is a folding L-shape antenna having an electric field of quarter wavelength at a frequency lower than that of the first antenna element, the position where the second antenna element is directly connected to the first antenna element is opposed to the taper-shape end portion of the first antenna element, and the first antenna element and the second antenna element do not interfere with each other by electrical characteristics at positions where the first antenna element and the second antenna element are disposed.

Due to the above described characteristics, the antenna device according to the present invention can obtain a good Voltage Standing Wave Ration (VSWR) value in a frequency band of more than 1.7 GHz by the first antenna element, and a good VSWR value in a frequency band around 0.8 GHz by the second antenna element.

In the antenna device of the present invention, the second antenna device is characterized that it adjusts impedance by partially different widths. This causes the antenna device of the present invention to obtain required properties.

Also, in the antenna device of the present invention, the first and second antenna elements are bent toward a dielectric support member and formed on the surface of the dielectric support member, thereby further miniaturizing the antenna device of the present invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a more complete understanding of the present disclosure and its advantages, reference is now made to the following description taken in conjunction with the accompanying drawings, in which like reference numerals represent like parts:

FIG. 1 illustrates an external view showing an antenna device according to one embodiment of the present invention;

FIGS. 2A-2B illustrate an external view showing an antenna device according to one embodiment of the present invention;

FIG. 3 illustrates an external view showing an antenna part of an antenna device according to one embodiment of the present invention;

FIGS. 4A and 4B illustrate models for investigating changes of the VSWR value according to the antenna element shape;

FIG. 5 illustrates VSWR values of respective antenna devices illustrated in FIGS. 4A and 4B;

FIGS. 6A to 6C illustrate models for investigating changes of the VSWR value according to the antenna element shape;

FIG. 7 illustrate VSWR values of respective antenna devices illustrated in FIG. 4B and FIGS. 6A to 6C;

FIGS. 8A to 8D illustrate current distribution according to frequencies, in the antenna element of the antenna device illustrated in FIG. 4B;

FIGS. 9A and 9B illustrate external views of another antenna device, which are for comparing to an antenna device according to the present invention;

FIG. 10 illustrates a VSWR value of the antenna device illustrated in FIG. 9A;

FIGS. 11A to 11D illustrate current distribution according to frequencies, in the antenna element of the antenna device illustrated in FIG. 9A;

FIGS. 12A to 12D illustrate current distribution according to frequencies, in the antenna element of the antenna device illustrated in FIG. 9A;

FIG. 13 illustrates a VSWR value of the antenna device according to one embodiment of the present invention, as illustrated in FIG. 1;

FIG. 14 illustrates an external view showing an antenna device according to another embodiment of the present invention;

FIG. 15 illustrates a VSWR value of the antenna device according to another embodiment of the present invention, as illustrated in FIG. 14;

FIGS. 16A-16B illustrate an external view showing an antenna device; and

FIG. 17 illustrates systems and frequency bands, which are covered by an antenna device according to the present invention.

### DETAILED DESCRIPTION OF THE INVENTION

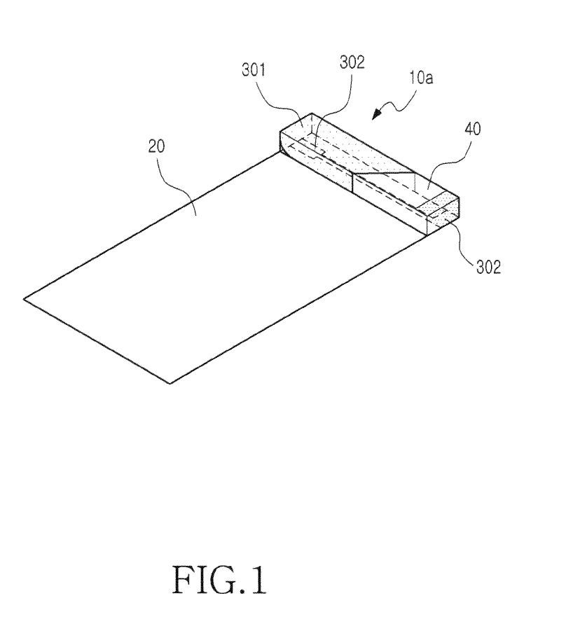

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications device.

Before the description of the present invention, an antenna device having a similar structure, disclosed in Japanese Patent Application No. 2007-334954, will be described briefly.

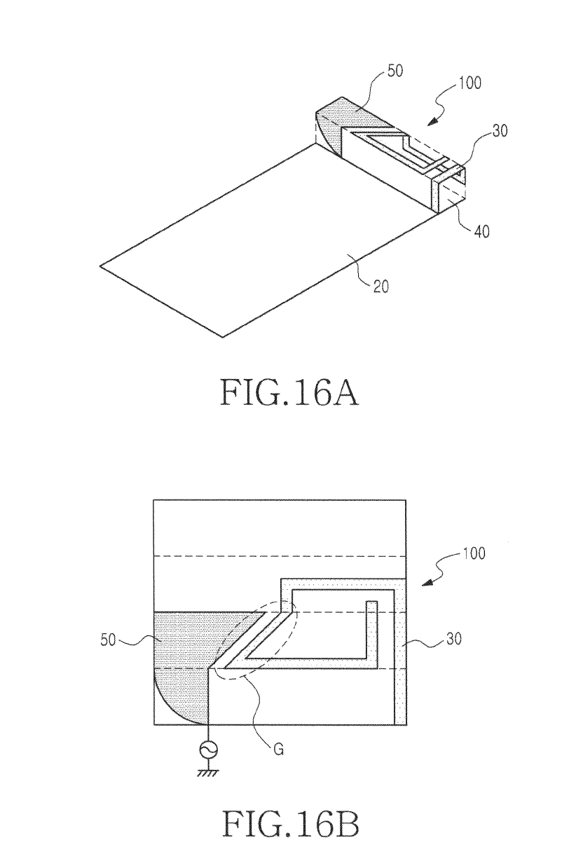

FIGS. 16A and 16B illustrate a multi-band antenna device disclosed in Japanese Patent Application No. 2007-334954. The antenna device 100 is a miniaturized multi-band antenna device with a simplified design and fabrication method, which includes a substrate 20 provided with a feed point and a short point, a UWB antenna 50 connected to the feed point, and a parasitic element 30 having a short circuit end connected to the short point, and an open end as the other end of the short circuit end. The parasitic element 30 operates by electromagnetic coupling with the UWB antenna 50. The UWB antenna 50 and the parasitic element 30 may be bent toward the surface of a square-shaped dielectric substance 40 and three-dimensionally formed.

The antenna device 100 includes a space G (illustrated in the dotted circle), between the UWB antenna 50 and the parasitic element 30, which is for electromagnetic coupling. Conversely, in an antenna device according to the present invention, space G (for electromagnetic coupling) is removed to achieve a more miniaturized antenna device.

Hereinafter, one embodiment of the present invention will be described.

FIG. 1 illustrates an antenna device 10a according to the present invention. The antenna device 10a includes a substrate 20, a first antenna element 301, a second antenna element 302, and a square-shaped dielectric substance 40. The first and second antenna elements 301 and 302 are formed on the surface of the square-shaped dielectric substance 40 by MID (Molded Interconnect Device) technology, or by the integral molding of thin sheet metal.

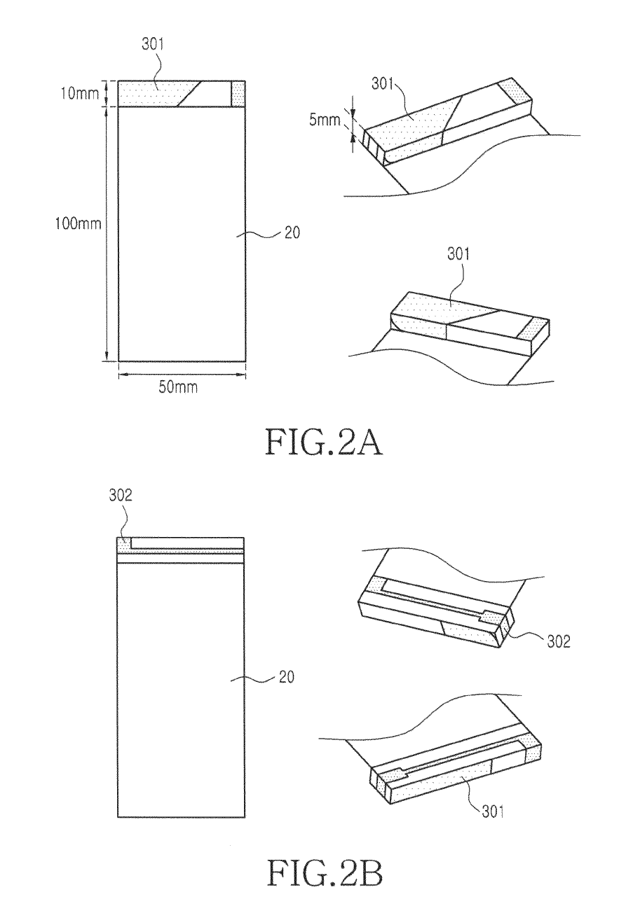

FIGS. 2A and 2B illustrate the exterior of the antenna device 10a. FIGS. 2A and 2B illustrate the outside and the inside of the substrate 20, respectively, with perspective views. The size of the substrate 20 is dimensioned for a general cellular terminal or PDA terminal, for example, 100 mm×50 mm. Also, for example, an antenna part including the antenna elements 301 and 302, and the dielectric substance 40 is dimensioned to be 10 mm×50 mm×5 mm, and include a volume of 2.5 cc.

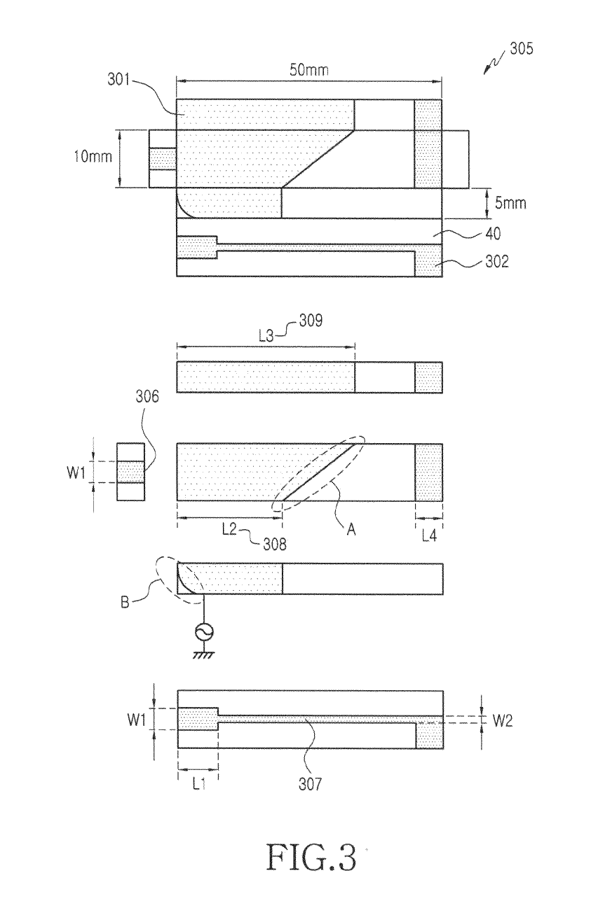

FIG. 3 illustrates a developed view of the antenna part of the antenna device 10a. FIG. 3 further illustrates example sizes of the antenna elements 301 and 302. As shown in FIG. 2, the antenna device 10a is disposed at one end in the longitudinal direction of the substrate 20, and is fed and operated by a terminal side.

The antenna part 305 of the antenna device 10a has the first and second antenna elements 301 and 302. It will be understood that, although the antenna elements 301 and 302 are described separately, the antenna elements 301 and 302 are integrally formed.

The first antenna element 301 is a right-left asymmetrical wide-band antenna including a taper-shape end portion A (illustrated inside the dotted circle) and a round-shape end portion B(illustrated inside the dotted circle), and is bent toward the dielectric substance 40 and formed on the surface of the dielectric substance 40. The first antenna element 301 makes it possible to obtain a good VSWR value of less than ‘3’ in a frequency band of more than 1.7 GHz. The lengths of two sides L2 308 and L3 309 positioned at both ends of the end portion A, for example, are within the ranges of 15˜25 mm, and 20˜35 mm, respectively. The end portion A of the first antenna element 301 contributes to the wide-band of the antenna device 10a, and the end portion B contributes to the adjustment of the amount of capacitance. Herein, although the end portion B has a round shape, it may have a taper shape according to embodiments.

Also, the second antenna element 302 is an antenna capable of obtaining a good VSWR value of less than ‘3’ in a frequency band around 0.8 GHZ, which is fabricated with partially varying widths (for example, the width W2 of the thinnest portion 307 is 1.5 mm). As described above, by partially varying the width of the second antenna element 302, the impedance of the antenna device 10a can be adjusted. Herein, the lengths of L1 and L2 of the first antenna element 301, and the width W1 of a joint portion 306 of the first antenna element 301 with the second antenna element 302 are set based on the resonance frequency matching. The second antenna element 302 is mounted at an end portion opposed to the end portion A of the first antenna element 301, and is bent toward the dielectric substance 40 and formed on the surface of the dielectric substance 40.

The second antenna element 302 can maintain resonance characteristics in a frequency band that is not secured by the first antenna element 301, that is, in a frequency band around 0.8 GHz. For this, the second antenna element 302 is connected directly to the first antenna element 301 at the point where the second antenna element 302 will not influence the operation characteristics (especially, the wide-band) of the first antenna element 301.

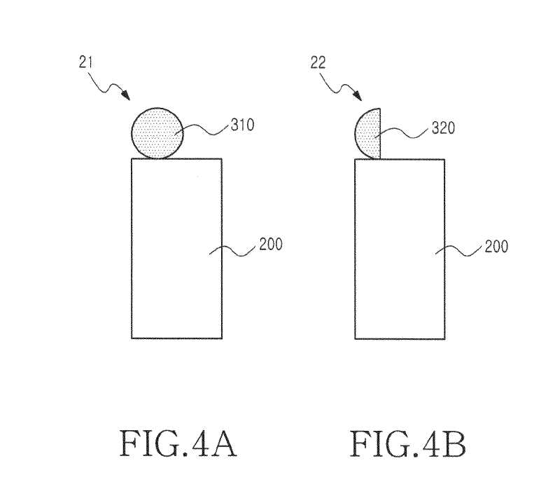

Hereinafter, the cause the antenna device 10a is structured as above will be described with reference to FIGS. 4 to 13.

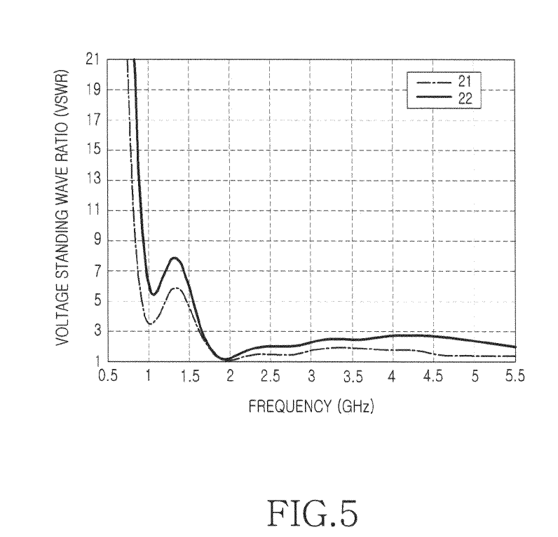

FIGS. 4A and 4B illustrate examples of a small planar monopole antenna with a wide-band frequency characteristic, which employ a substrate 200 with a size of 100 mm×50 mm (that is, a size of a printed wiring board (PWB) of a general portable terminal). Herein, an antenna device 21 includes a circular antenna element 310 (for example, circular antenna element may be dimensioned to have a diameter of 14 mm) provided at one end of the substrate 200. Meanwhile, an antenna device 22 includes a semicircular antenna element 320 provided at one end of the substrate 200, the antenna element 320 being the half of the antenna element 310 of the antenna device 21. The VSWR values of the antenna devices 21 and 22 are shown in FIG. 5.

The antenna device 21 has a wide-band by current flowing through the antenna in multiple frequency modes due to the shape of the circular antenna element 310, and satisfies a VSWR value of less than ‘3’ (a general value of a terminal antenna) in a frequency band of more than 1.7 GHz. Also, in the case of the antenna device 22, the VSWR value is slightly low, as compared to the antenna device 21, because the area of the antenna element 320 is the half of that of the antenna element 310. However, the VSWR value is enough for a wide-band.

As shown in a dotted portion in FIG. 5, however, the antenna devices 21 and 22 cannot have VSWR values of less than ‘3’ (which shows resonance characteristics) in a frequency band around 0.8 GHz. The frequency of 0.8 GHz band currently is used in Global System for Mobile Communications (GSM) 800 and GSM 950 utilized outside of Japan, and is used for a cellular communication type, such as Personal Digital Cellular (PDC), utilized inside of Japan. Thus, it is preferable to obtain a good VSWR value in this frequency band.

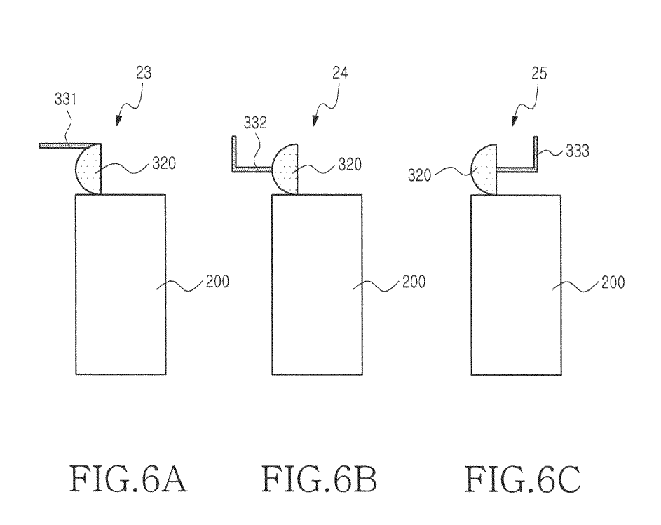

Therefore, as shown in FIGS. 6A, 6B, and 6C, in order to obtain a resonance characteristic of 0.8 GHz band, the antenna device 22 was modified. For example, the semicircular antenna element 320 may be wired with antenna elements 331, 332, and 333 with about quarter wavelength with respect to a wavelength of 0.8 GHz. The antenna elements 331, 332, and 333 are disposed at different positions of the antenna element 320, respectively.

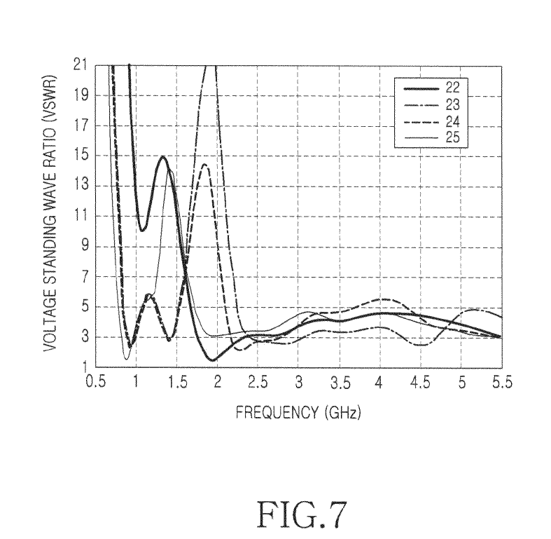

An antenna device 23 shown in FIG. 6A is formed by providing the antenna element 331 at the leading end of the antenna element 320, and an antenna device 24 shown in FIG. 6B is formed by mounting the antenna element 332 at a position proximate to the middle point of the circular arc of the antenna element 320. Also, an antenna device 25 shown in FIG. 6C is formed by mounting the antenna element 333 at a position proximate to the middle point of the chord of the antenna element 320. VSWR values of the antenna devices 23, 24, and 25, together with the VSWR value of the antenna device 22, are shown in FIG. 7.

FIG. 7 illustrates that the antenna devices 23, 24, and 25 can obtain resonance characteristics in a frequency band around 0.8 GHz. However, more specifically, the antenna devices 23 and 24 shown in FIGS. 6A and 6B cannot obtain the resonance characteristics in a range of 1.7 GHz˜2.2 GHz, which can be obtained by the antenna device 22 shown in FIG. 4B.

Meanwhile, the antenna device 25 shown in FIG. 6C obtains resonance characteristics in a frequency band of 0.8 GHz while maintaining almost all the resonance characteristics of the antenna device 22 in a range of 1.7 GHz˜2.2 GHz. This is caused by the following reasons.

In general, in antenna element design of a multi-mode built-in antenna, it is necessary to branch off or capacity-combine elements in configuring multiple antenna elements. Herein, it is preferable to wire the respective elements at positions where they do not interfere with each other by used frequencies. Thus, it is considered to provide elements in the vicinity of low current amplitude.

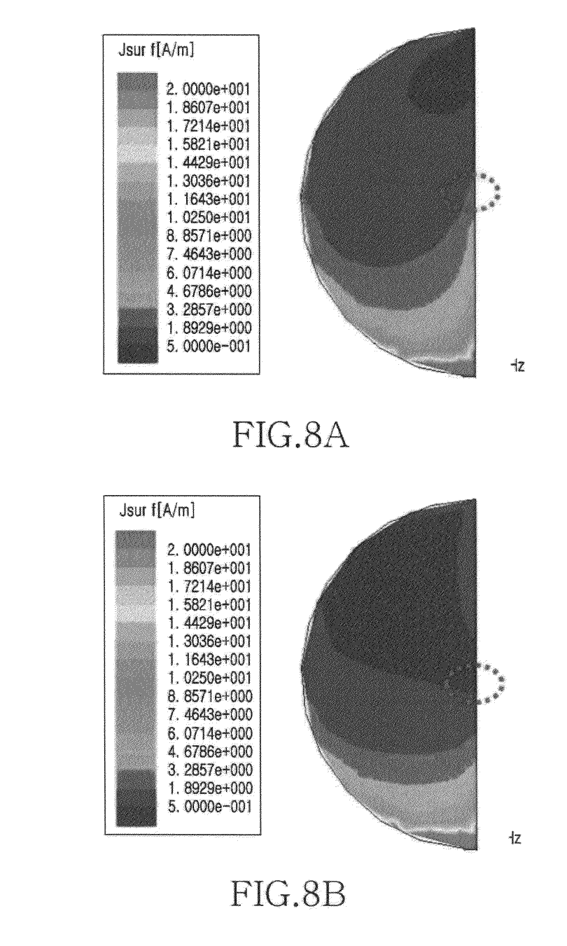

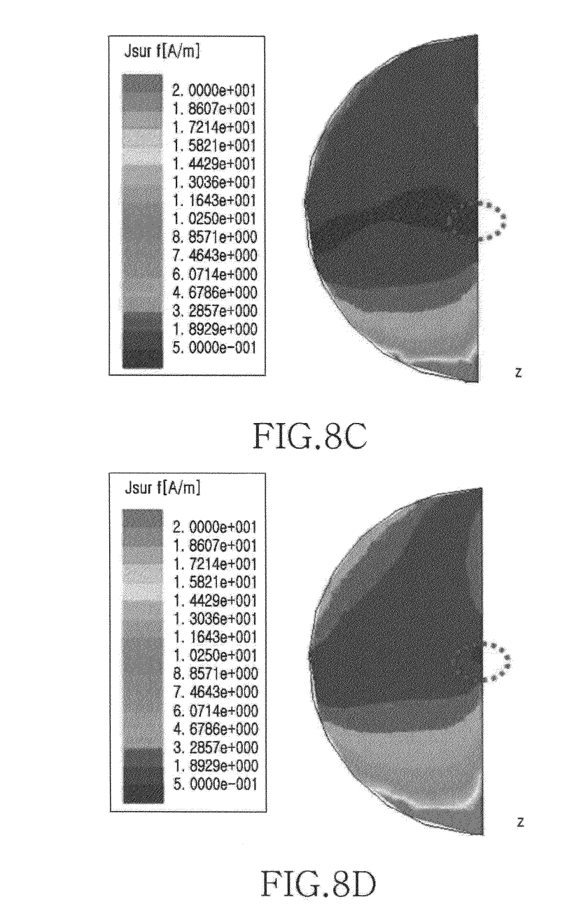

The current distribution in the semicircular antenna element 320 of the antenna device 22 has been analyzed by using three-dimensional electromagnetic field simulation. FIGS. 8A, 8B, 8C, and 8D illustrate the current distribution according to frequencies in the range of 2˜5 GHz. In FIGS. 8A, 8B, 8C, and 8D, the darker portion indicates low current amplitude, and the lighter portion indicates high current amplitude. Thus, referring to the drawings, in 2 GHz, the low current amplitude is shown at the leading end of the antenna element 320, while in 2˜5 GHz, the low current amplitude is shown at the vicinity of the middle point of the chord of the antenna element 320, that is, the portion wrapped by the dotted line.

Taking this into consideration, it is determined that it is preferable to mount the folding L-shape 0.8 GHz antenna element 333 at a position proximate to the middle point of the chord of the antenna element 320, similar to the antenna device 25 of FIG. 6C. This is because the position has low current amplitude, and does not contribute to the wide-band of the first antenna element 310.

Above all, as illustrated in the simulation, in the semicircular antenna element 320, the lowest current amplitude in 2 GHz is shown at the leading end portion of the antenna element 320 (not at the position proximate to the middle point of the chord). Although the antenna element is mounted at the leading end portion, like the antenna device 23 in FIG. 6A, it is impossible to achieve the required properties. This can be clear from FIG. 7.

Also, in the case of the antenna devices 21 and 22 shown in FIGS. 4A and 4B, at low frequencies, current strongly flows proximate to the circle center of the antenna elements 310 and 320. Then, as the frequency increases, the current strongly flows proximate to the circumference. Therefore, in order to achieve required performance at a low frequency of 0.8 GHz, it is assumed that another antenna element is preferably mounted at a position proximate to the circular center of the antenna elements 310 and 320.

When an antenna device is configured by newly mounting another antenna element to a wide-band antenna taking these properties into consideration, it is possible to achieve a multi-band antenna by further adding bands at low frequencies while maintaining almost all the frequency band characteristics of the wide-band antenna.

However, as described above, a portable terminal requires miniaturization, and it is difficult to mount a large external antenna, like the antenna device 25. Accordingly, the principle and design of the above mentioned multi-band antenna device disclosed in Japanese Patent Application No 2007-334954 were employed to reduce the antenna size.

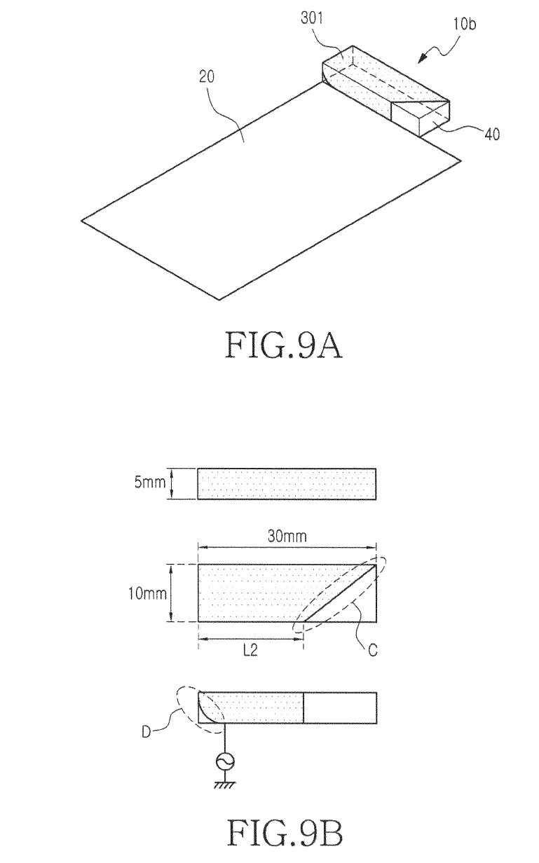

Referring to FIG. 16, in the multi-band antenna device disclosed in Japanese Patent Application No 2007-334954, the miniaturization of an antenna is achieved by bending and forming an antenna element into a three-dimensional structure. FIGS. 9A-9B illustrates the state where the antenna element 301 is bent by the technique of bending and forming an antenna element into a three-dimensional structure.

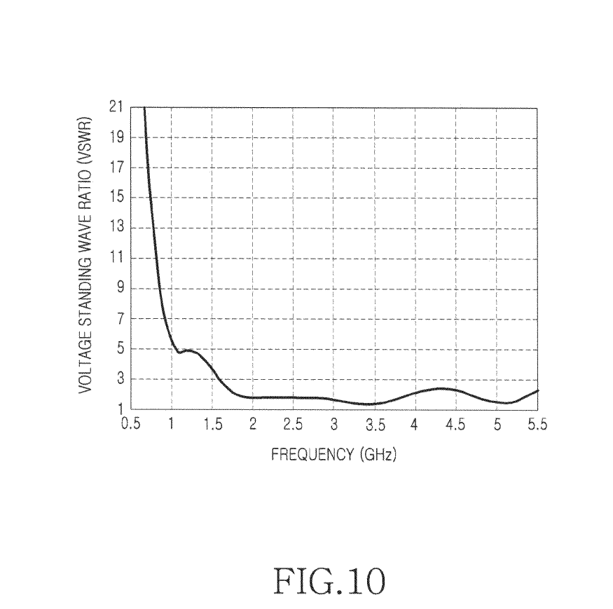

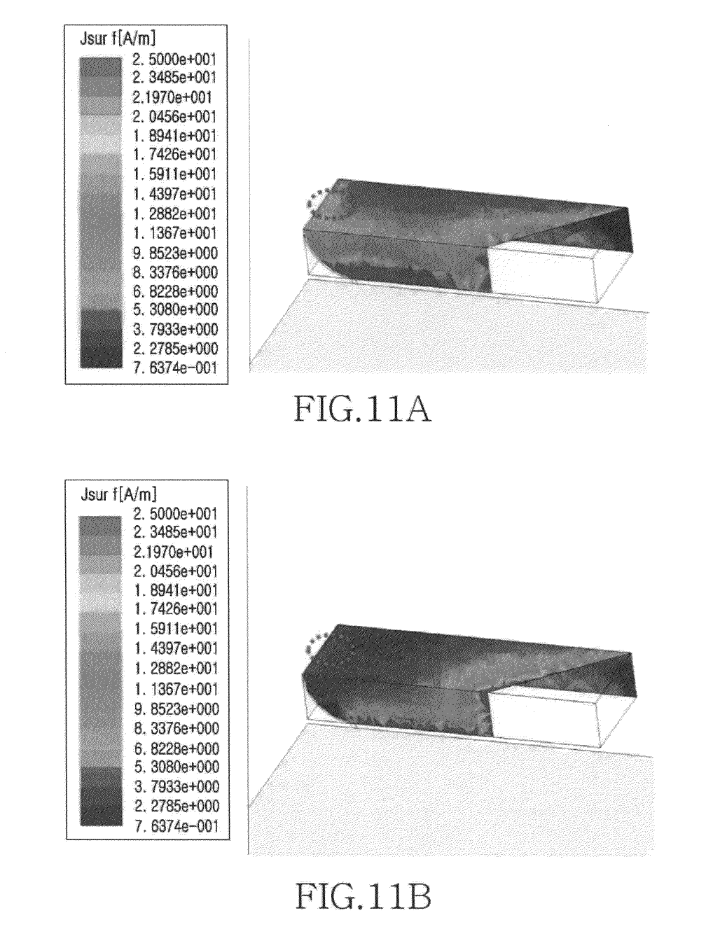

Referring to FIGS. 9A-9B, the bent antenna element 301 is disposed on the surface of the dielectric substance 40 with a size of 10 mm×30 mm×5 mm. The size of the antenna element is small enough to be used for a built-in antenna for a portable terminal. The VSWR value of the antenna device 10b is shown in FIG. 10.

Through the comparison of the VSWR value of the antenna device 10b with the VSWR value of the antenna device 22 of FIG. 4b, as shown in FIG. 5, it can be seen that both antenna devices have substantially similar VSWR values and wide-band properties. In the antenna device 10b, a taper-shape end portion C (illustrated in the dotted circle) operates on the wide-band, and a round-shape end portion D (illustrated in the dotted circle) operates on the wide-band and impedance adjustment. However, as can be clearly seen in FIG. 10, the resonance characteristics in 0.8 GHz are not obtained. Accordingly, in order to obtain the resonance characteristics in this band, an element for 0.8 GHz is additionally mounted.

As described in the antenna devices 23, 24, and 25 with reference to FIGS. 6A, 6B, and 6C, the position and shape of an additionally mounted antenna element may cause the waveform-change, and value deterioration of the VSWR value, and a narrowband in the entire antenna device. Therefore, for the antenna element 301 constituting the antenna device 10b, current distribution was analyzed by using three-dimensional electromagnetic field simulation.

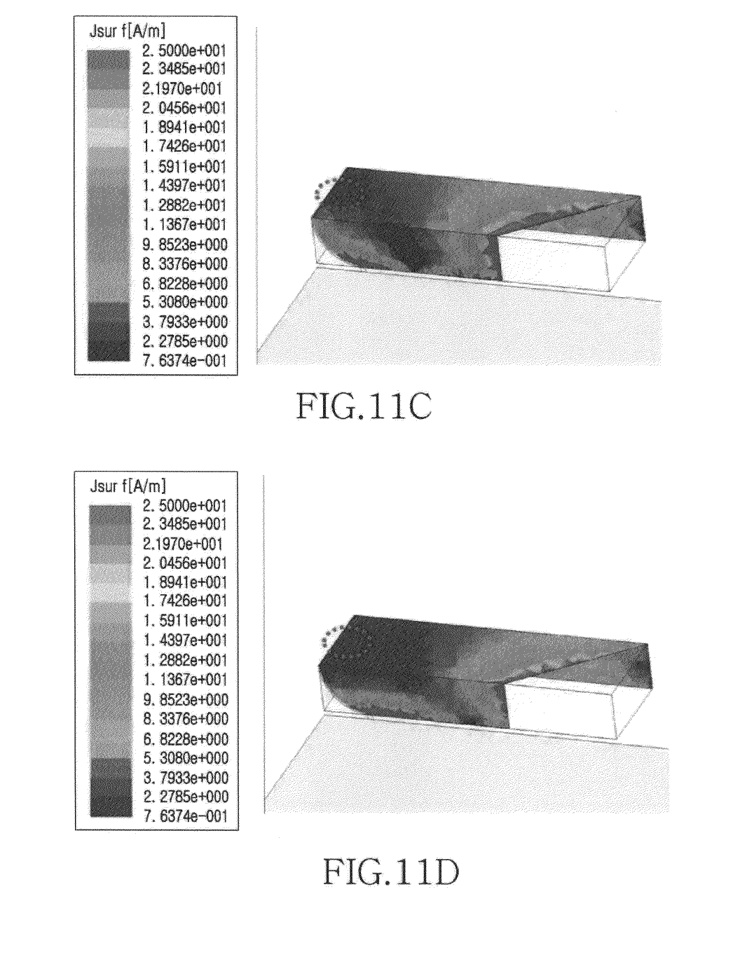

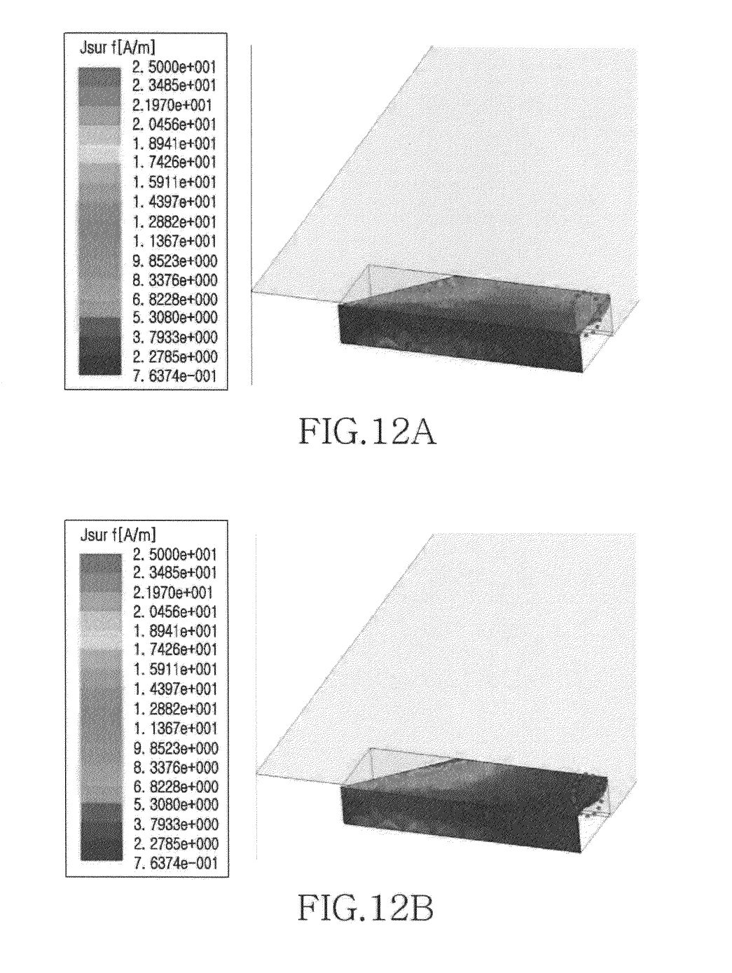

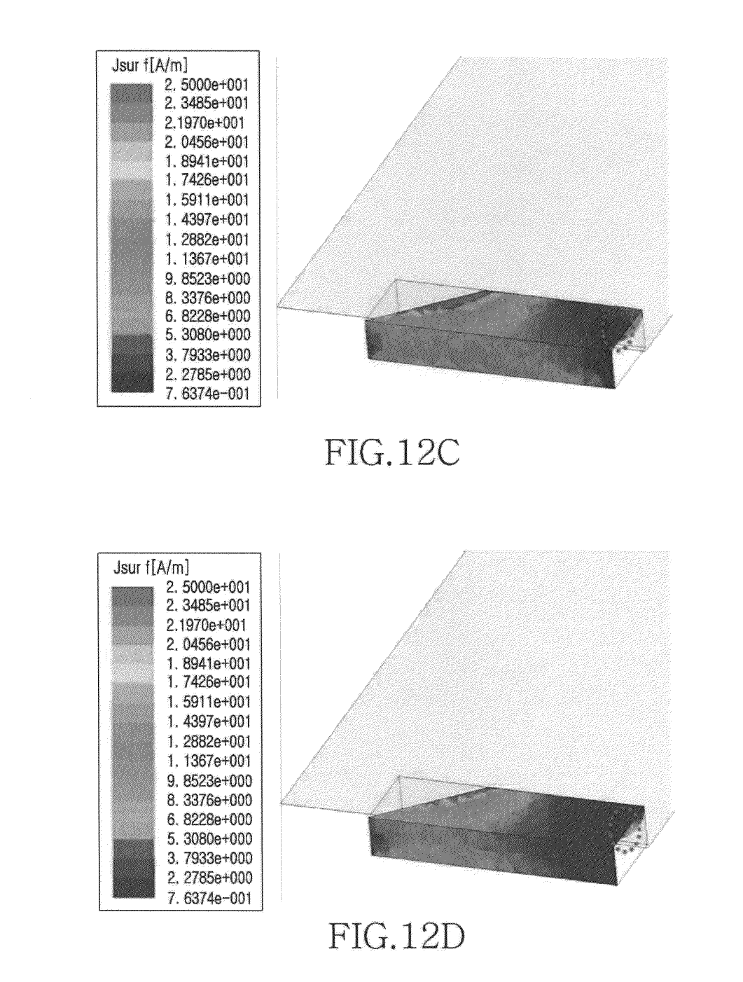

FIGS. 11A-11D and 12 illustrate the analyzed result according to frequencies in a frequency range of 2˜5 GHZ. Similar to FIG. 8, the darker portion indicates low current amplitude, and the lighter portion indicates high current amplitude. Also, FIGS. 11A-11D illustrate the antenna element 301 from the view of a substrate side, and FIG. 12 illustartes the antenna element 301 from the view of a back side.

Referring to FIGS. 11A-11D and 12, the current amplitude in a dotted portion is relatively low at any frequency within the range of 2˜5 GHz. Therefore, in some embodiments an antenna element is mounted with a 0.8 GHz band on the portion.

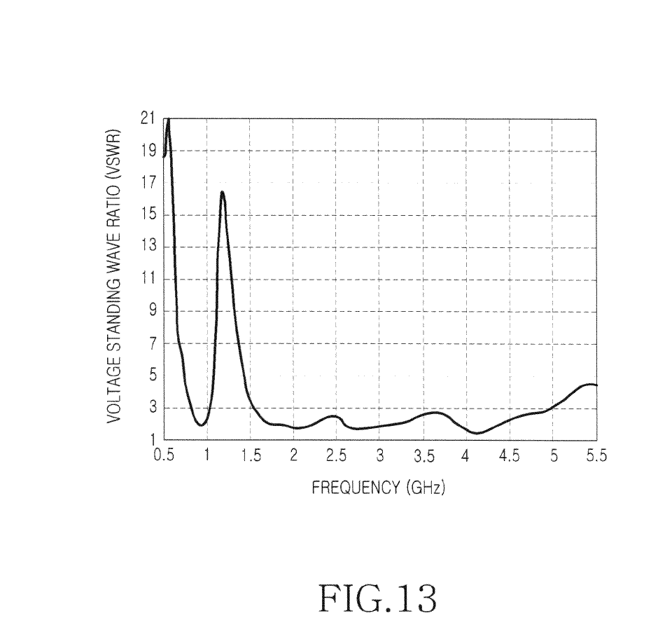

The antenna device of the present invention, which is designed and wired by taking this into consideration, can be the same as the antenna device 10a shown in FIG. 1. Also, the VSWR value of the antenna device 10a is shown in FIG. 13, and the antenna device 10a can obtain resonance characteristics at about 0.8 GHz while maintaining almost the same frequency-VSWR characteristic as the antenna device 10b shown in FIGS. 9A-9B. Therefore, in a frequency band in a range of 824-960 MHz used for GSM 850 and GSM 900, and in a frequency band in a range of 1.575˜4.8 GHz used for Global Positioning System (GPS), Digital Cross-connect System (DCS), Personal Communications Service (PCS), Universal Mobile Telecommunications System (UMTS), MobileWiMax, and Ultra-Wide Band Low (UWB_Low), it is possible to obtain a VSWR value of less than 3.

In general, when an antenna has a small-size and a multi-band, the adverse influences, such as narrow-band or impedance degradation, occur by an increase in the Q value, a decrease in the antenna impedance, and electromagnetic coupling between the antenna elements. This has been an obstacle for miniaturization. However, according to the present invention with the above mentioned structure, it is possible to achieve an ultra-wide-band small-size built-in multi-band antenna without such problems.

Meanwhile, in addition to a cellular system for GSM, DCS, PCS, and UMTS (IMT 2000), UWB, Radio Frequency Identification (RF-ID), GPS, Bluetooth®, a TV-FM receiving system, or the like are included. Then, other wireless systems tend to show an increase in the number of systems and tend to be multifunctional. However, the increase in the number of systems in proportion to the number of antennas is not allowable in terms of the antenna device space as well as the production cost.

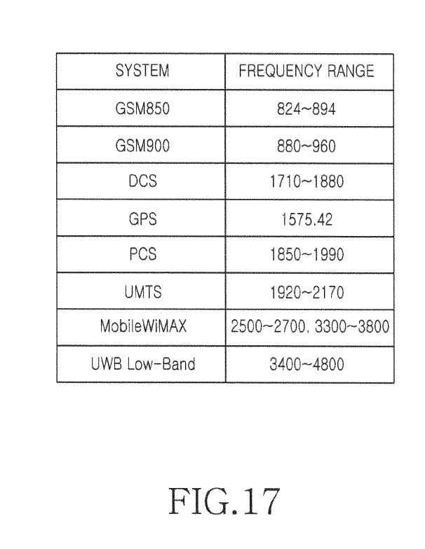

The antenna device of the present invention can exclude, by only one antenna device, from a frequency band of less than 5 GHz usable by a portable terminal, HF band short-range communication (13.56 MHz) with a frequency lower than 0.8 GHZ, which is usable by all mobile systems, or all of the frequency bands (470-770 MHz) for 1 seg (a service for partially receiving 1 segment, used for a portable phone or a mobile terminal). Accordingly, the antenna device can cover respective wireless systems shown in FIG. 17, and is expected to be highly effective.

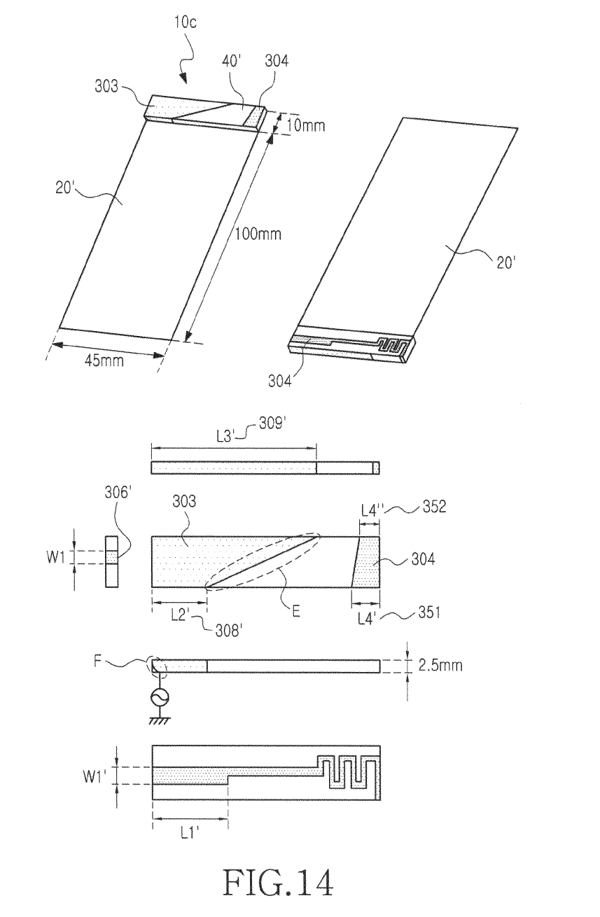

Meanwhile, as the small-size design is considered to be important in a portable terminal, and a wireless terminal requires miniaturization, it may be considered to require a smaller-sized antenna device. FIG. 14 illustrates an example of a smaller-sized antenna device.

The antenna device 10c includes a substrate 20′ dimensioned to be of a size of 100 mm×45 mm, and an antenna part dimensioned to be a size of 10 mm×45 mm×2.5 mm (volume of about 1.1 cc), and the first and second elements 303 and 304 are formed on the surface of a square-shaped dielectric substance 40′.

The first antenna element 303 includes a taper-shape end portion E (illustrated in the dotted circle), and a round-shape end portion F (illustrated in the dotted circle), and the lengths of two sides L2′ 308′ and L3′ 309′ disposed at both ends of the end portion E, for example, are within the ranges of 7˜15 mm, and 25˜40 mm. Also, in the second antenna element 304, a width W1′ of a joint portion 306′ joining with the first antenna element 303, for example, is 4.5 mm, and the both end lengths L4′ 351 and L4″ 352 of the portion opposed to the end portion E of the first antenna element 303, for example, are 6 mm, and 4 mm, respectively.

In the same manner as the above described embodiment, respective lengths of L1′, L2′, and W1′ are set based on the resonance frequency matching.

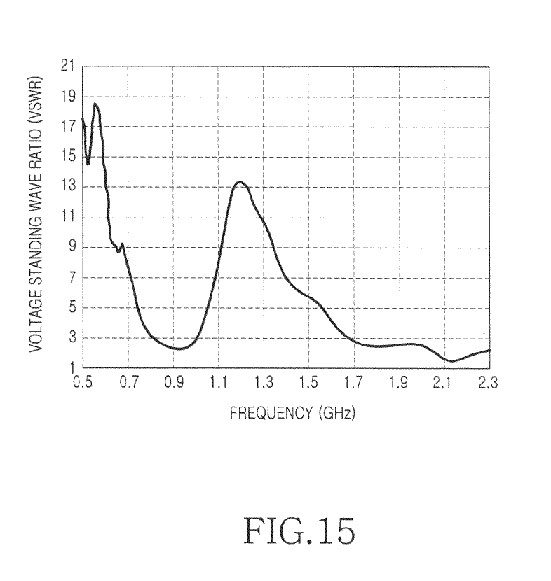

FIG. 15 illustrates a VSWR value of the antenna device 10c. As shown, according to the antenna device 10c, in the frequency bands of GSM 850, GSM 900, DCS, PCS, and UMTS used for many current portable terminals, a VSWR value of less than ‘3’ is obtained.

According to the present invention, even though the antenna device is miniaturized, it is possible to achieve a wide-band multi-band antenna.

According to the present invention, it is possible to achieve an ultra wide-band antenna device having electrical properties to secure all data communication bands and cellular bands of GSM 850, GSM 900, GPS, DCS, PCS, UMTS, mWiMax, and UWB_Low. Also, even though the antenna size is reduced to a volume of about 1 cc, the properties can be satisfied in the frequency bands of current portable terminals for GSM 850, GSM 900, DCS, PCS, and UMTS. Thus, it is possible to achieve a miniaturized wide-band antenna device, and thereby contribute to the miniaturization of a terminal device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An antenna device comprising:
a substrate comprising a feed point;
a right-left asymmetrical first antenna element with a predetermined width; and
a second antenna element mounted to the first antenna element,
wherein the first antenna element has a taper-shape end portion contributing to a wide-band, and a round-shape or a taper-shape end portion precisely adjusting amount of capacitance, and is fed by connection of the round-shape or taper-shape end portion to the feed point, and
the second antenna element is coupled to the first antenna element at a position where the position does not contribute to the wide-band, and maintains resonance characteristics in a low frequency band where the resonance characteristics are not secured by the wide-band of the first antenna element.

2. The antenna device as claimed in claim 1, wherein the first antenna element is a wide-band monopole antenna having an electric field of quarter wavelength, the second antenna element is a folding L-shape antenna having an electric field of quarter wavelength at a lower frequency than the first antenna element.

3. The antenna device as claimed in claim 2, wherein the position where the second antenna element is coupled to the first antenna element is opposed to the taper-shape end portion of the first antenna element, and
the first antenna element and the second antenna element do not interfere with each other by electrical characteristics at positions where the first antenna element and the second antenna element are disposed.

4. The antenna device as claimed in claim 3, wherein the second antenna element adjusts impedance by having partially varying widths.

5. The antenna device as claimed in claim 4, wherein the first antenna element and the second antenna element are bent toward a surface of a dielectric support member and formed on the surface of the dielectric support member.

6. The antenna device as claimed in claim 1, wherein the first antenna element and the second antenna element are bent toward a surface of a dielectric support member and formed on the surface of the dielectric support member.

7. The antenna device as claimed in claim 1, wherein the antenna device is configured to operate in at least one of:
a plurality of data communication bands; and
at least one of Global System for Mobile Communications 850, Global System for Mobile Communications 900, Global Positioning Systems, Digital Cross-connect System, Personal Communications Service, Universal Mobile Telecommunications System, Mobile Wireless Max (Mobile WiMax), and Ultra-Wide Band low.

8. A mobile wireless device capable of communicating in a wireless communication network, the telecommunications device comprising:
an antenna device, the antenna device comprising:
a substrate comprising a feed point;
a right-left asymmetrical first antenna element with a predetermined width; and
a second antenna element mounted to the first antenna element,
wherein the first antenna element has a taper-shape end portion contributing to a wide-band, and a round-shape or a taper-shape end portion precisely adjusting amount of capacitance, and is fed by connection of the round-shape or taper-shape end portion to the feed point, and
the second antenna element is coupled to the first antenna element at a position where the position does not contribute to the wide-band, and maintains resonance characteristics in a low frequency band where the resonance characteristics are not secured by the wide-band of the first antenna element.

9. The wireless device as claimed in claim 8, wherein the first antenna element is a wide-band monopole antenna having an electric field of quarter wavelength, the second antenna element is a folding L-shape antenna having an electric field of quarter wavelength at a lower frequency than the first antenna element.

10. The wireless device as claimed in claim 9, wherein the position where the second antenna element is coupled to the first antenna element is opposed to the taper-shape end portion of the first antenna element, and
the first antenna element and the second antenna element do not interfere with each other by electrical characteristics at positions where the first antenna element and the second antenna element are disposed.

11. The wireless device as claimed in claim 10, wherein the second antenna element adjusts impedance by having partially varying widths.

12. The wireless device as claimed in claim 11, wherein the first antenna element and the second antenna element are bent toward a surface of a dielectric support member and formed on the surface of the dielectric support member.

13. The wireless device as claimed in claim 8, wherein the first antenna element and the second antenna element are bent toward a surface of a dielectric support member and formed on the surface of the dielectric support member.

14. The wireless device as claimed in claim 8, wherein the antenna device is configured to operate in at least one of:
a plurality of data communication bands; and
at least one of Global System for Mobile Communications 850, Global System for Mobile Communications 900, Global Positioning Systems, Digital Cross-connect System, Personal Communications Service, Universal Mobile Telecommunications System, Mobile Wireless Max (Mobile WiMax), and Ultra-Wide Band low.

15. A method of communicating in a wireless communication network, the method comprising:
transmitting at least one of voice and data communications with an antenna device; and
receiving at least one of voice and data communications with the antenna device, the antenna device comprising:
a substrate comprising a feed point;
a right-left asymmetrical first antenna element with a predetermined width; and
a second antenna element mounted to the first antenna element,
wherein the first antenna element has a taper-shape end portion contributing to a wide-band, and a round-shape or a taper-shape end portion precisely adjusting amount of capacitance, and is fed by connection of the round-shape or taper-shape end portion to the feed point, and
the second antenna element is coupled to the first antenna element at a position where the position does not contribute to the wide-band, and maintains resonance characteristics in a low frequency band where the resonance characteristics are not secured by the wide-band of the first antenna element.

16. The method as claimed in claim 15, wherein the first antenna element is a wide-band monopole antenna having an electric field of quarter wavelength, the second antenna element is a folding L-shape antenna having an electric field of quarter wavelength at a lower frequency than the first antenna element.

17. The method as claimed in claim 16, wherein the position where the second antenna element is coupled to the first antenna element is opposed to the taper-shape end portion of the first antenna element, and
the first antenna element and the second antenna element do not interfere with each other by electrical characteristics at positions where the first antenna element and the second antenna element are disposed.

18. The method as claimed in claim 17, further comprising, adjusting, by the second antenna element, the impedance, the impedance adjusted by having partially varying widths.

19. The method as claimed in claim 15, wherein the first antenna element and the second antenna element are bent toward a surface of a dielectric support member and formed on the surface of the dielectric support member.

20. The method as claimed in claim 15, wherein transmitting and receiving each occur in at least one of:
a plurality of data communication bands; and
at least one of Global System for Mobile Communications 850, Global System for Mobile Communications 900, Global Positioning Systems, Digital Cross-connect System, Personal Communications Service, Universal Mobile Telecommunications System, Mobile Wireless Max (Mobile WiMax), and Ultra-Wide Band low.
